(19) United States
(12) Patent Application Publication
(10) Pub. No.: US 2017/0183078 A1
(43) Pub. Date: Jun. 29, 2017

(54) DOOR OF A BLENDED BODY AIRCRAFT INSTALLED IN THE LEADING EDGE AND WITH LATERAL EDGES PARALLEL TO THE PLANE OF SYMMETRY OF THE AIRCRAFT

(71) Applicant: Airbus Operations (S.A.S.), Toulouse Cedex 9 (FR)

(72) Inventors: Olivier CAZALS, Blagnac (FR); Jaime GENTY DE LA SAGNE, Toulouse (FR)

(21) Appl. No.: 15/388,836

(22) Filed: Dec. 22, 2016

(30) Foreign Application Priority Data
Dec. 23, 2015 (FR) 15 63181

(51) Int. Cl. B64C 1/14

(52) U.S. Cl. CPC B64C 1/1461; B64C 1/1415; B64C 1/143; B64C 1/06

(57) ABSTRACT

A flying wing or blended body aircraft comprising at least one door installed in the leading edge of the aircraft. The lateral edges of the door extend each in a plane parallel to the plane of symmetry of the aircraft, when the door is closed. It reduces the aerodynamic penalties of a door installed in the leading edge of such an aircraft. It also reduces noise related to airflow at the door, and improves the robustness of the aircraft with respect to impacts.

### TECHNICAL DOMAIN

The invention relates to a particular arrangement of a door for an aircraft of the flying wing or blended wing body type.

It concerns a door for closing an opening to the outside of the aircraft, in particular a door for loading and unloading material known as a “cargo door”. Such a door can also be used for entrance and exit of passengers.

### PRIOR ART

Different aircraft configurations are known in the prior art.

The invention more particularly concerns configurations of the flying wing and blended wing body type.

A flying wing makes no distinction between the fuselage and the wings, the on-board payload being situated inside a wing. In other words, there is no fuselage distinct from the wing. A longitudinal axis can be defined in a flying wing. A configuration of the flying wing type must not be confused with a configuration of the flying disk type presenting a symmetry of revolution.

A blended wing body is an intermediate configuration between a flying wing and a conventional fuselage, without any clear distinction between the fuselage and the wings.

The door cutout implemented in these configurations originates directly from the cutout implemented in a more conventional configuration, where the wings and the fuselage form two clearly distinct elements.

In a conventional configuration, the doors are situated on the fuselage of the aircraft, with their lateral edges in planes orthogonal to the outside surface of the fuselage. In an aircraft of the flying wing type, or in a blended wing body, the doors are therefore situated in the leading edge, as illustrated in FIG. 1 of document U.S. Pat. No. 6,595,466.

It should be remembered that the leading edge is the part that first comes into contact with the fluid when the flying wing or blended wing body is in flight.

FIGS. 1A and 1B illustrate this cutout of the doors 101 according to the prior art, in a blended wing body 100. FIG. 1A illustrates the aircraft in a top view and FIG. 1B in a bottom view.

It can be seen in particular in FIGS. 1A and 1B that, in a sectional view in a plane called “horizontal” of the aircraft, each door then extends into a region of the leading edge that has a curved profile, or a profile inclined at an angle relative to the plane of symmetry of the aircraft. This curved or inclined-at-an-angle profile originates from the fact that the aircraft is of the flying wing or blended wing body type.

A horizontal plane of the aircraft here designates a plane orthogonal to the plane of symmetry of the aircraft and parallel to the longitudinal axis (Ox) of the aircraft.

Being situated in the leading edge, the doors have a significant impact on the aerodynamics of the flying wing, respectively of the blended wing body.

One aim of this invention is to propose a configuration of these doors that is particularly advantageous in terms of the aerodynamics of the aircraft.

Another aim of this invention is to improve the accessibility to the aircraft during operations on the ground.

### DESCRIPTION OF THE INVENTION

This aim is achieved with an aircraft of the flying wing or blended wing body type, comprising at least one door extending over the leading edge of the aircraft, for closing an opening to the outside, lateral edges of the door extending each in a plane parallel to the plane of symmetry of the aircraft, when the door is closed.

In other words, lateral edges of a doorframe associated with said door extend each in a plane parallel to the plane of symmetry of the aircraft. Such a doorframe is integral with the remainder of the aircraft, and surrounds the door when it is closed. The closed position of the door corresponds to the position in which it completely obturates the opening to the outside.

The aircraft being of the flying wing or blended wing body type, the door (and its frame) according to the invention extends into a region of the leading edge that has, in a horizontal plane as defined above, a curved profile, or a profile inclined at an angle relative to the plane of symmetry of the aircraft.

Said inclination is comprised for example between 30° and 80°.

The door is installed in the leading edge of the aircraft, that is to say at a location with particularly easy access and which is unobstructed. Accessibility to the aircraft during operations on the ground is therefore optimum.

In flight, the airflow around the aircraft follows lines that extend in planes parallel to the plane of symmetry of the aircraft, while following the aircraft profile. Consequently, by locating the lateral edges of the door in planes parallel to this plane of symmetry, their impact on the aerodynamics of the aircraft is minimized, at the same time allowing the door to be installed in the leading edge. The risk of creating vortices is thereby limited, even in the presence of a gap between an outside surface of the door and an outside surface of the remainder of the aircraft, or in the presence of a misalignment between these two surfaces.

These vortices increase aircraft drag. The invention therefore allows the drag of a flying wing or blended wing body to be reduced.

These vortices also cause noise nuisance, and so the invention makes it possible to limit noise nuisance in the vicinity of the aircraft, in particular inside the aircraft, for the on-board passengers and crewmembers inside the aircraft, and outside the aircraft within the framework of respecting the regulatory acoustic restrictions.

In flight, the aircraft is exposed to impacts, in particular bird strikes, and impacts of objects or debris called FOD, standing for Foreign Object Damage. The door and the doorframe constitute an area sensitive to these impacts. They must therefore be dimensioned accordingly in order to be robust against these impacts. According to the invention, the lateral edges of the door extend parallel to the direction of the airflow when the door is closed, which improves the robustness of the aircraft with respect to these impacts. In other words, the orientation of the lateral cutouts of the door in planes parallel to the airflow assists resistance to these impacts.

The door is preferably mounted to pivot around an axis of rotation, which extends in a plane substantially orthogonal to the plane of symmetry of the aircraft.

Advantageously, when the door is closed, more than half the surface of the door extends below a line of the stagnation points of the aerodynamic flow around the leading edge of the aircraft.

When the door is closed, the door can extend entirely below the line of the stagnation points of the aerodynamic flow around the leading edge of the aircraft.

The door is advantageously mounted to pivot on means of rotation that extend along its lower edge.

The aircraft according to the invention can furthermore comprise a conveyor belt, a first end of which is mounted integral with the aircraft interior, on the side of the means of rotation, and a second end of which is mounted integral with the door, on the side opposite the means of rotation, so that opening the door causes the conveyor belt to be deployed.

The door preferably has an angled cutout extending between a lateral edge and an upper edge of the door, on the side of the plane of symmetry of the aircraft.

The invention also relates to a door for an aircraft, which forms, with an aircraft element including an opening to the outside, an aircraft according to the invention.

### BRIEF DESCRIPTION OF THE DRAWINGS

This invention will be better understood on reading the description of embodiment examples given simply as an indication, and not at all limitative, making reference to the attached drawings, among which:

FIGS. 1A and 1B illustrate in a diagrammatic way a cutout of doors according to the prior art, in a blended wing body shown as a top view and as a bottom view;

FIGS. 2A and 2B illustrate in a diagrammatic way a cutout of doors according to the invention, in a blended wing body shown as a top view and as a bottom view;

FIG. 3 illustrates in a diagrammatic way, as a front view, a part of the aircraft illustrated in FIGS. 2A and 2B;

FIG. 4 illustrates in a diagrammatic way, as a perspective view, a part of the aircraft illustrated in FIGS. 2A and 2B;

FIG. 5 illustrates in a diagrammatic way a part of the aircraft illustrated in FIGS. 2A and 2B, as a perspective view, and when the door according to the invention is open;

FIG. 6 illustrates a particularly advantageous embodiment of an aircraft according to the invention, shown partially and in perspective, and which associates a conveyor belt for cargo and a folding stairway for ground personnel; and

FIGS. 7A and 7B illustrate a comparison between the floor space of means of access to an aircraft according to whether access to the aircraft is through a door according to the prior art or according to the invention.

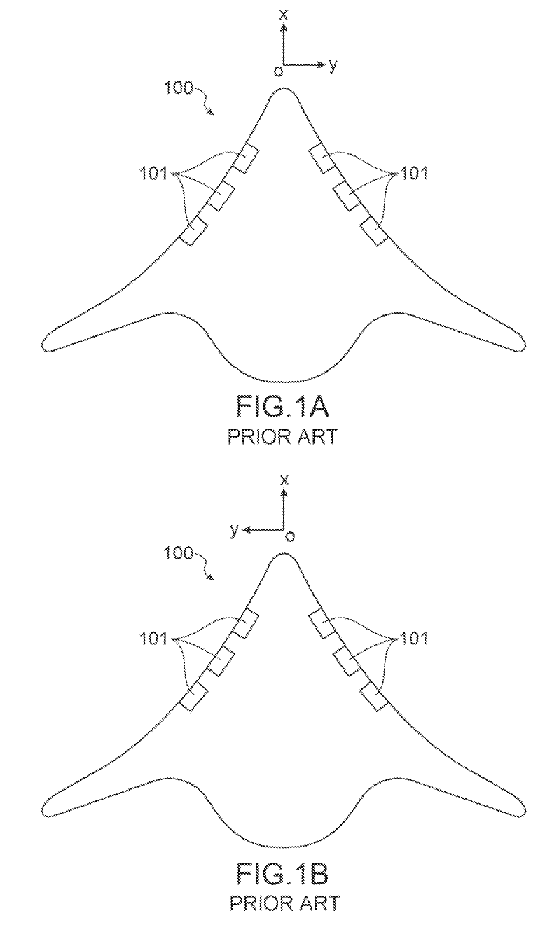

### DETAILED DESCRIPTION OF PARTICULAR EMBODIMENTS

In all of the text, the characteristics relating to the location of the door and of its lateral edges, when the door is closed, also apply to the location and to the lateral edges of a doorframe, integral with the remainder of the aircraft and surrounding the door when it is closed.

The location of a door in the leading edge of a flying wing or blended wing body does not constitute an optimum location from an aerodynamic viewpoint.

The invention proposes to keep the door and its frame at the leading edge of the aircraft, but to adapt their configuration so as to limit aerodynamic losses.

The proposed door is positioned at a location with easy access and which is unobstructed, where loading passengers and/or material is facilitated.

The proposed invention eliminates the aerodynamic penalties of a door according to the prior art, since a possible misalignment between an outside surface of the door and an outside surface of the remainder of the aircraft is parallel to the local airflow, which reduces vortices.

Thanks to the invention, the aircraft has excellent aerodynamic properties in spite of a possible gap between an outside surface of the door and an outside surface of the remainder of the aircraft. Likewise, a possible misalignment between the outside surface of the door and the outside surface of the remainder of the aircraft does not adversely affect the aerodynamic qualities of the aircraft as a whole.

In other words, the door according to the invention does not involve any particularly heavy stresses on the joint between the edges of the door and the remainder of the aircraft.

In all the figures, the views are positioned relative to an orthonormed system defined by three axes (Ox), (Oy), (Oz), wherein:
the axis (Ox) corresponds to the longitudinal axis of the aircraft. It is parallel to a plane of symmetry 210 of the aircraft;
the axis (Oy) corresponds to the transverse axis of the aircraft, perpendicular to the axis (Ox); and
the axis (Oz) corresponds to the axis of the height in the aircraft, perpendicular to the axes (Ox) and (Oy).

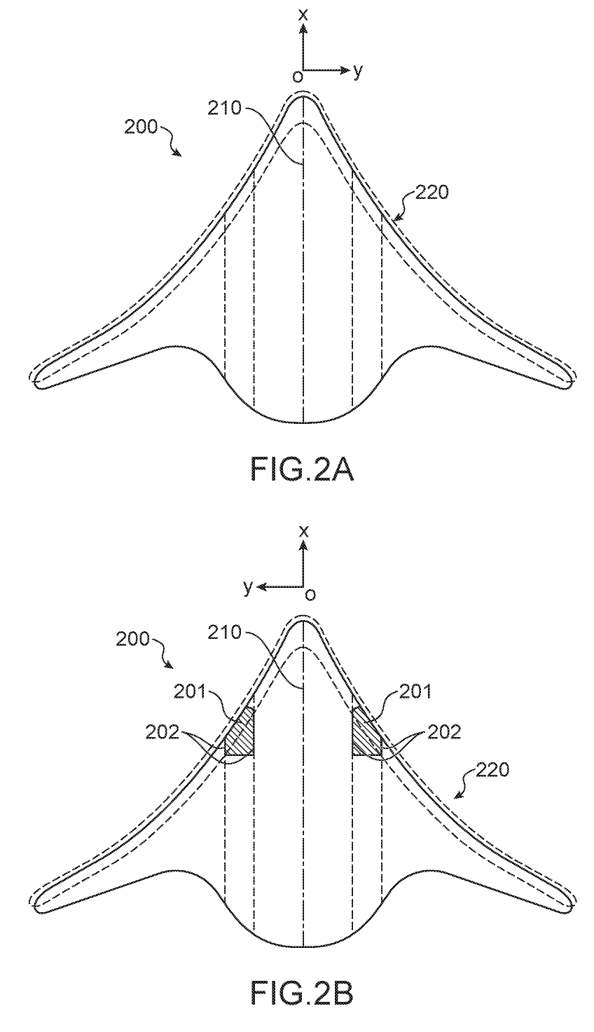

FIGS. 2A and 2B illustrate in a diagrammatic way a cutout of doors according to the invention, in a blended wing body 200, shown as a top view (FIG. 2A) and as a bottom view (FIG. 2B).

The plane of symmetry 210 of the aircraft is shown as a dot-and-dash line. The plane of symmetry 210 is a vertical plane parallel to the plane (xOz) passing through the center of the aircraft along (Oy).

Doors 201 (shown as shading in FIG. 2B) extend on either side of this plane of symmetry. In other words, at least one door according to the invention extends on either side of this plane of symmetry.

When closed, the doors are a blended part of the outside profile of the aircraft. They therefore have a non-flat shape that blends into the aerodynamic profile of the aircraft.

When closed, each door 201 extends in particular over the leading edge 220 of the aircraft.

The leading edge 220 is surrounded by dotted lines in FIGS. 2A and 2B. This is the front part of the aircraft, which faces the airflow when the aircraft is in flight.

As illustrated in particular in FIG. 2B, each door 201 is delimited by at least four edges or cutouts.

Each door 201 has two lateral edges 202, an upper edge and a lower edge.

The upper edge, illustrated more particularly in FIG. 4, is the highest edge of the door, along the axis (Oz), when the door is closed (the axis (Oz) is oriented from the ground towards the sky). The upper edge extends between the two lateral edges 202.

The lower edge, illustrated more particularly in FIG. 4, is the lowest edge of the door, along the axis (Oz), when the door is closed. It also extends between the two lateral edges 202.

When the door is closed, each lateral edge 202 extends between the upper edge and the lower edge, in a plane parallel to the plane of symmetry 210. In FIGS. 2A and 2B, dotted lines show the planes parallel to the plane of symmetry 210, each accommodating a lateral edge 202.

In flight, and more particularly at zero roll and yaw angles, the airflow around the aircraft follows lines that extend in planes parallel to the plane of symmetry of the aircraft, while following the aircraft profile. Each lateral edge 202 then extends in the same plane as the line of airflow incident upon this edge. Furthermore, each lateral edge 202 is then substantially parallel to this line of airflow, the latter substantially following the aircraft profile.

Thus, even in the presence of surface defects at the joint between the door and the remainder of the outside surface of the aircraft, the creation of vortices is avoided, and aircraft drag is consequently reduced. In other words, the aerodynamic penalties of a door installed in the leading edge of this type of aircraft are reduced.

Internal and external noise nuisance in connection with the airflow at the door contour is also reduced.

The lateral edges of the door extend substantially parallel to a direction of bird strikes and impacts of other objects of the FOD type on each door 201. The robustness of the aircraft, in particular at the lateral edges of the door and at the lateral jambs of the doorframe, is thereby improved. In other words, the structural design of the area of the aircraft that accommodates the door cutout is improved.

According to an advantageous embodiment illustrated in the figures, each door 201 extends integrally over the intrados of the aircraft, that is to say over the lower surface of the aircraft.

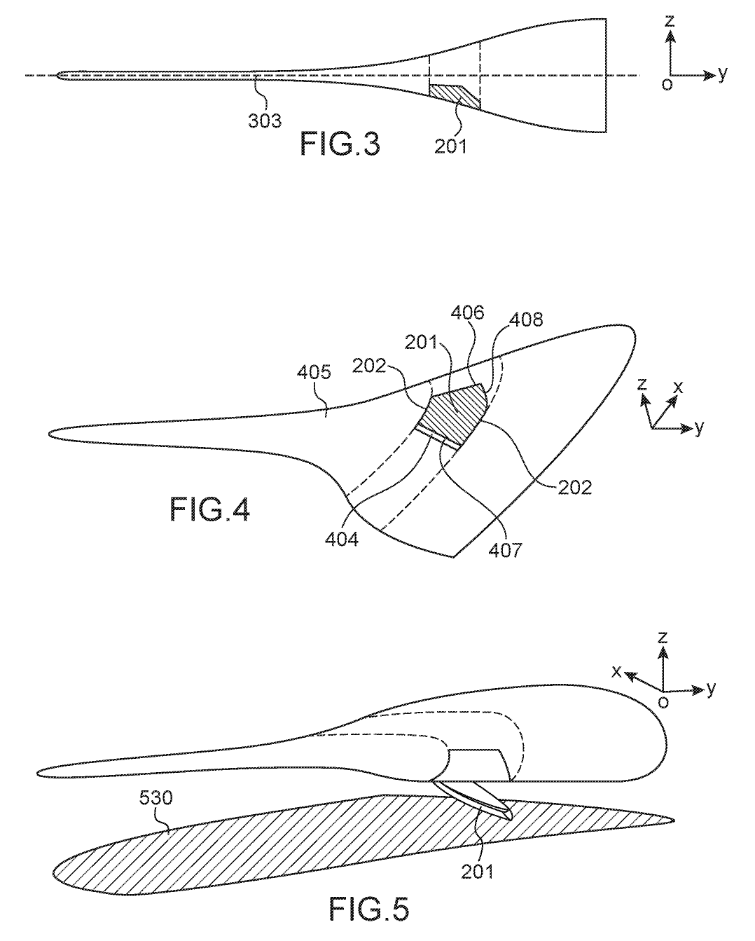

This characteristic is illustrated in particular in FIG. 3, which shows, as a front view, one half of the aircraft illustrated in FIGS. 2A and 2B.

In FIG. 3, vertical lines show the planes parallel to the plane of symmetry of the aircraft, each accommodating a lateral edge of a door 201 when the door is closed.

FIG. 3 also shows the line 303 of the stagnation points of the aerodynamic flow around the leading edge. In what follows, this line 303 is called stagnation line.

The stagnation line 303 is the line separating the airflowing over the intrados of the aircraft and the airflowing over the extrados of the aircraft. The stagnation line is situated on the leading edge of the aircraft.

In the example illustrated in FIG. 3, when closed, each door 201 is situated entirely below the stagnation line 303, that is to say entirely in the intrados part of the aircraft.

Thus, all of the door contours are situated on the intrados, where the airflow is not very sensitive to the surface conditions of the aircraft. The impact of these contours on the aerodynamics of the aircraft is therefore reduced more, in particular the impact of the door edges not parallel to the airflow. Any separation of the boundary layer of the airflow around the aircraft is thereby avoided, and the aircraft drag is consequently reduced.

The greater the proportion of the door surface situated on the intrados, the better the aerodynamic performance of the aircraft.

Furthermore, this arrangement of the door on the intrados reduces the apparent surface of the door, considered on a front view of the aircraft. Consequently, it is the door surface exposed to bird strikes and impacts of other objects of the FOD type that is reduced. This significantly reduces the probability of an impact on the door, of birds and other objects of the FOD type.

In the example shown in FIG. 3, the door is situated entirely on the intrados, and its upper edge is away from the stagnation line 303.

It should be noted that the door cannot extend just anywhere on the intrados, since the door extends in any event over the leading edge of the flying wing or blended wing body.

As a variant, when closed, the door is situated entirely on the intrados, and its upper edge extends along the stagnation line 303.

According to another variant, not shown, when closed, the door is only partially situated on the intrados, below the stagnation line 303.

Preferably, more than half, and even more than two thirds, if not more than 80% of its surface is then situated on the intrados, below the stagnation line 303. In particular, the door can be situated with more than half its height on the intrados, and even more than two thirds, if not more than 80% of its height (dimension along (Oz)).

The outer surface of the door 201 can be placed slightly back or slightly forward relative to the outer surface of the remainder of the aircraft (misalignment of surfaces).

A gap can also exist between the outside surface of the door and the outside surface of the aircraft, this gap extending between the outer contours of the door and the inner contours of the doorframe.

In this case, when closed, the door forms, with the remainder of the aircraft, recesses that extend along the lateral edges of the door, parallel to the airflow. These recesses, or slots, extend in particular over the leading edge. They are not problematic for the aerodynamics of the aircraft and even form barriers of the wing fence type, reducing span-wise airflow. Such barriers can be embodied on the wings of an aircraft with a fuselage in order to reduce the risks of stalling. Span-wise airflow designates a parasitic airflow, not parallel to the main airflow. Reducing this span-wise airflow improves the overall aerodynamic performance of the aircraft, including with respect to stalling.

FIG. 4 illustrates, in a diagrammatic way, as a perspective view, the half of an aircraft shown in FIG. 3. A door 201 situated on the intrados of the aircraft is present, and its lateral edges 202 extend in planes parallel to the plane of symmetry of said aircraft, when the door is closed.

FIG. 4 also illustrates the lower edge 407 and the upper edge 406 of the door, as defined previously.

The upper edge 406 here extends parallel to the stagnation line.

The door 201 is mounted to pivot relative to the doorframe as mentioned in the introduction, not shown, said doorframe being integral with the remainder 405 of the aircraft, and delimiting the opening that the door is intended to obturate.

The door is therefore adapted to pivot around an axis of rotation, between a closed position in which it is placed inside this doorframe and an open position in which it is placed outside this doorframe.

This rotation is achieved thanks to a hinge 404 forming means of rotating the door 201, relative to the remainder 405 of the aircraft.

The axis of rotation associated with these means of rotation 404 extends along the lower edge 407 of the door, on the side opposite the leading edge and the stagnation line.

In particular, the axis of rotation is parallel, if not actually merged, with this lower edge 407.

This lower edge 407, and with it the axis of rotation around which the door 201 is mounted to pivot, extend here in a plane substantially orthogonal to the plane of symmetry 210.

Substantially means +/−5°, preferably +/−2° and even +/−1°.

The lower edge 407, and with it the axis of rotation, thus extend in a plane substantially orthogonal to the planes accommodating the lateral edges, which simplifies the kinetics of opening the door.

In particular, the kinetics of opening the door are then a simple rotation.

In particular, it is not necessary to implement, before this rotation, a translation of the door upwards and then towards the outside of the aircraft.

FIG. 4 also illustrates an angled cutout 408 of the door 201, which extends between the upper edge 406 of the door, and the lateral edge 202 nearest to the plane of symmetry of the aircraft.

This angled cutout 408 allows an opening amplitude of the door to be increased by preventing a corner of the door, at the angle between these two edges, from abutting against the ground when the aircraft is parked on a horizontal plane and the door is open.

FIG. 5 illustrates, as a perspective view, the half of an aircraft shown in FIG. 4, when the door 201 is open.

FIG. 5 shows, as shading, the orthogonal projection 530 of this half of an aircraft, on the ground, when the aircraft is parked on a horizontal plane. This projection corresponds to the floor space of the aircraft.

It can be seen that the arrangement of the door, totally or for the most part on the intrados, allows the floor space of the aircraft to be the same, whether the door 201 is open or closed. It can also be noticed that the arrangement of the axis of rotation on the lower edge 407 of the door offers the door 201 an optimum travel.

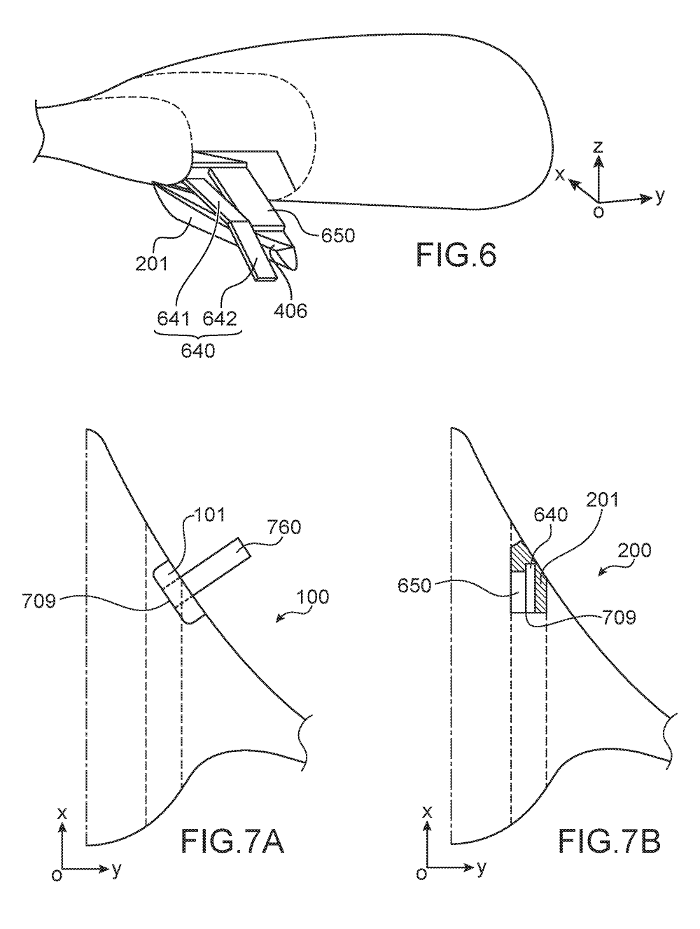

FIG. 6 illustrates a particularly advantageous embodiment of the invention, wherein each door according to the invention is equipped with a conveyor belt 650, for loading and unloading baggage or merchandise (cargo). As in the preceding figure, FIG. 6 only shows one half of an aircraft, as a perspective view.

As illustrated in FIGS. 4 and 5, the door 201 is situated on the intrados of the aircraft, and it is adapted to turn around an axis parallel to the lower edge of the door.

The conveyor belt 650 is mounted integral with the door, so that the rotation of the door 201 towards the outside, when the door is opened, causes the conveyor belt 650 to be deployed outside the aircraft.

In particular, a first end of the conveyor belt 650 is secured to the door 201, on the side of the upper edge 406 of the door, side of the aircraft interior.

The other end of the conveyor belt is integral with the aircraft interior, on the side opposite the upper edge 406 of the door. This other end is, for example, integral with a floor inside the aircraft or integral with the door, on the side of its lower edge.

FIG. 6 also shows a stairway 640 for passengers or ground personnel to go up and down.

The stairway 640 here is formed in two folding parts 641, 642.

A first part 641 of the stairway has a first end secured to the door 201, on the side of the upper edge 406 of the door, inside the aircraft.

The other end of this first part 641 is integral with the aircraft interior, on the side opposite the upper edge 406 of the door. This other end is, for example, integral with a floor inside the aircraft or integral with the door, on the side of its lower edge.

The rotation of the door 201 when it opens causes this first part 641 to be deployed outside the aircraft. It is then simply sufficient to unfold the second part 642 to extend the stairway down to the ground.

FIGS. 7A and 7B illustrate a comparison of the floor space of the means of access to a door of an aircraft of the flying wing or blended wing body type, according to whether access to the aircraft is through a door according to the prior art or a door according to the invention.

In both cases, access to the door is from the ground. The comparison is of a total size of the set comprising the aircraft and means of access to the door.

FIG. 7A shows, as a transparent top view, one half of an aircraft 100 according to the prior art. The door extends mainly on the extrados, with its lateral edges situated in planes orthogonal to the leading edge. Access to this door is made thanks to a removable stairway 760, which extends from a lower jamb 709 of the doorframe.

Since the door extends mainly on the aircraft extrados, this lower jamb 709 is situated close to the outer limits of the aircraft, considered as a top view. In other words, the orthogonal projection of the lower jamb 709, in a horizontal plane (xOy), is situated close to the limits of the orthogonal projection of the aircraft in the same plane (this projection being defined in FIG. 5).

The stairway 760 thus extends from the lower jamb 709 down to a location on the ground situated outside this orthogonal projection of the aircraft.

FIG. 7B shows, as a transparent top view, one half of an aircraft 200 as described in particular with reference to FIG. 6.

In particular, access to the door 201 is made thanks to an on-board stairway 640 and an on-board conveyor belt 630, which each extend from the lower jamb 709 of the doorframe.

In FIG. 7B, the stairway 640 and the conveyor belt 630 are shown deployed outside the aircraft.

Since the door 201 extends totally or almost totally on the aircraft intrados, the lower jamb 709 of the doorframe is situated well inside the outer limits of the aircraft, considered as a top view. In other words, the orthogonal projection of the lower jamb 709, in a horizontal plane (xOy), is situated away from the limits of the orthogonal projection of the aircraft in the same plane (this projection being defined in FIG. 5).

The stairway 640 and the conveyor belt 650, deployed, thus extend from the lower jamb 709 down to a location on the ground situated inside the outer limits of the aircraft.

The invention therefore allows the size on the ground (or floor space) of a set formed by the aircraft and means of access to it from the ground to be limited, in particular during loading and unloading operations of passengers and/or merchandise.

These observations also apply when the loading and unloading means are not taken on board inside the aircraft, but brought to the door from outside the aircraft.

The invention relates to an aircraft as a whole, comprising both the door 201 and the remainder of the aircraft.

The invention also relates to the door 201 considered alone.

The figures described above present the invention within the framework of a blended wing body. It will also be possible to implement the invention, in the same way, within the framework of a flying wing, without a central body.

1. An aircraft of a flying wing or blended wing body type, the aircraft comprising at least one door for closing an opening to the outside, said door extending over a leading edge of the aircraft, wherein lateral edges of the door extend each in a plane parallel to a plane of symmetry of the aircraft when the door is closed.

2. The aircraft according to claim 1, wherein the door extends into a region of the leading edge that has a curved profile, or a profile inclined at an angle relative to the plane of symmetry of the aircraft, said profile being defined in a horizontal plane of the aircraft.

3. The aircraft according to claim 1, wherein the door is mounted to pivot around an axis of rotation, which extends in a plane substantially orthogonal to the plane of symmetry of the aircraft.

4. The aircraft according to claim 1, wherein, when the door is closed, more than half of a surface of the door extends below a line of stagnation points of aerodynamic flow around the leading edge of the aircraft.

5. The aircraft according to claim 4, wherein, when the door is closed, an entirety of the door extends below the line of the stagnation points of the aerodynamic flow around the leading edge of the aircraft.

6. The aircraft according to claim 1, wherein the door is mounted to pivot on a rotation device that extends along a lower edge of the door.

7. The aircraft according to claim 6, further comprising a conveyor belt, a first end of which is mounted integral with an interior of the aircraft, on a side of the rotation device, and a second end of which is mounted integral with the door, on a side opposite the rotation device, so that opening the door causes the conveyor belt to be deployed.

8. The aircraft according to claim 6, wherein the door has an angled cutout extending between a lateral edge and an upper edge of the door, on a side of the plane of symmetry of the aircraft.

9. The aircraft according to claim 1, comprising a plurality of doors according to claim 1, distributed on either side of the plane of symmetry of the aircraft.

10. A door for an aircraft, wherein the door forms, with an aircraft element including an opening to outside, an aircraft according to claim 1.
